(19) United States
(12) Patent Application Publication
(10) Pub. No.: US 2009/0167658 A1
(43) Pub. Date: Jul. 2, 2009

(54) Image display device

(76) Inventors: Yasukuni Yamane, Shiki-gun Nara (JP); Masayuki Takahashi, Kitakatsuragi-gun Nara (JP); Kazuhiro Uehara, Tenri-shi Nara (JP)

Correspondence Address: HARNESS, DICKEY & PIERCE, P.L.C., P.O. BOX 8910, RESTON, VA, 20195, US

(21) Appl. No.: 11/991,466

(22) PCT Filed: Jul. 12, 2006
(86) PCT No.: PCT/JP2006/313896

§ 371 Date: Mar. 5, 2008

(30) Foreign Application Priority Data
Sep. 8, 2005 (JP) 2005-261403

(51) Int. Cl. G09G 3/36

(52) U.S. Cl. 345/89; 345/102

(57) ABSTRACT

In one embodiment of the present invention, luminance information of a video signal inputted thereto is weighted by a weighting section. An image characteristic value determination section, by one frame, takes an average of the weighted luminance information, thereby determining an image characteristic value of one frame. A backlight controlling section sets luminance of the backlight at a backlight luminance determination section in accordance with the image characteristic value determined by the image characteristic value determination section and performs luminance correction.

### TECHNICAL FIELD

The present invention relates to a display device, in particular, an image display device including a light source and a light modulation device for changing luminance of a display image by attenuating light from the light source in accordance with a video signal.

### BACKGROUND ART

Some liquid crystal image display devices have been configured as transmission-type image display devices having light source means. The transmission-type image display device requires a light source because the liquid crystal panel (the light modulation device) thereof is that of a non-emissive type, i.e., the liquid crystal panel itself does not illuminate. A direct-view-type liquid crystal image display device is provided with a light irradiation section called a backlight behind the liquid crystal panel thereof. A fluorescent tube called a cold-cathode tube is generally used as a light source. A projective-type liquid crystal image display device, popularly termed a liquid crystal projector, receives luminance to be projected on a screen from a lamp light source such as a Halogen lamp or a metal halide lamp.

Recently, in order to make the image quality of a liquid crystal image display device higher or clear, there have been proposed various improvement methods for dynamically adjusting the contrast of a video signal and the luminance of a light source in accordance with an incessantly changing video signal.

FIG. 19 illustrates a structure of a liquid crystal image display device disclosed in Patent Document 1. In FIG. 19, 201 represents an LCD panel; 202 represents a backlight; 203 represents a backlight controlling section; 204 represents an average luminance level detector circuit; 205 represents a display controlling section; and 206 represents an input.

A video signal to be displayed on the LCD panel 201 is inputted from the input 206 in the form of, for example, a YPbPr signal (a luminance signal and a color-difference signal). The display controlling section 205 performs control for displaying the inputted video signal on the LCD panel 201. Specifically, the display controlling section 205 performs operations such as the conversion of the YPbPr signal into an RGB signal, changing an order of the video signals according to a driving method of the LCD panel 201, the most suitable gamma correction for the LCD panel 201, and the like.

The backlight 202 is a light source for the LCD panel 201 to obtain luminance. The backlight controlling section 203 controls the light modulation of the backlight 202. The average luminance level detector circuit 204 detects an average luminance level of a video signal. The backlight controlling section 203 performs luminance control on the backlight 202 in such a manner that the higher the detected average luminance level, the lower the luminance of the backlight 202.

By these operations, display luminance is controlled in accordance with the average luminance level of the video signal. Accordingly, this effectively prevents such a problem that a viewer of the image display device feel a display image to be too bright or, reversely, too dark. Thereby, this makes it possible to display a clear display screen image.

A screen luminance (brightness) of the image display device is determined by the product of a light transmission of the LCD panel 201 multiplied by a luminescent luminance of the backlight 202. If a constant luminance of the backlight 202 is irrelevant to the video signal, a gradation of the video signal to be displayed solely depends on the light transmission of the LCD panel 201. Thus, the display performance of the image display device is accordingly determined by a dynamic range (the display performance of luminance of each of white and black) within which the LCD panel 201 can display an image.

However, the visual display performance of the image display device exceeds the dynamic range (the display performance of luminance of each of white and black) within which the LCD panel 201 can display an image by, as stated, performing the luminance control on the backlight 202 in accordance with the input video signal.

As for other conventional improvement methods for dynamically performing luminance adjustment (luminance control) of the backlight, for example, there is a method disclosed in Patent Document 2 (U.S. Pat. No. 3,495,362).

This conventional improvement method disclosed in the patent document 2 is also for detecting the average luminance level (APL) of the input video signal and, in accordance with the detected average luminance level, controlling light intensity of the light for irradiating a display element.

Specifically, in a case where the detected average luminance level is equal to or less than the first predetermined value, the light intensity of the light irradiating the display element is controlled in such a manner that the light intensity is adjusted to the predetermined lowest level or the vicinity thereof. On the other hand, in a case where the detected average luminance level is above the first predetermined value, the light intensity of the light irradiating the display element is controlled in such a manner that the light intensity is continuously increased along with a rise of the average luminance level.

This makes it possible to dynamically adjust luminance according to a scene of a video image, remedy problems: lack of a brightness feeling at a bright scene and a graying of black level of a dark scene, and improve a contrast feeling. Also, in a case of the dark scene, that is, the case where an APL of the input video signal is in a range less than a predetermined threshold, the light intensity of the light irradiating the display element is controlled in such a manner that the light intensity is adjusted to the predetermined lowest level or the vicinity thereof. This makes it possible to further remedy the problem of a graying of black level of the dark scene, and thus, improve a contrast feeling further.

Patent Document 2 further describes the division of the luminance level of the input video signal into a plurality of luminance level classifications and determination of a histogram distribution of the luminance level classifications. According to Patent Document 2, the light intensity of the light irradiating the display element is fixed at a predetermined level according to a predetermined distribution status in a case where the determined histogram distribution of each divided classification is in the predetermined distribution status.

This makes it possible to extract more precisely characteristics of a scene of a video image, which are not simply determined solely from the result of detection of APL, by controlling the light intensity of the light irradiating the display element based on the histogram distribution. In this way, the quality of the display image can be improved by controlling the light intensity of the light irradiating the display element more properly according to the characteristics of the scene of the video image.

Besides, Patent Document 3 (U.S. Pat. No. 3,215,388) and Patent Document 4 (U.S. Pat. No. 3,513,312) also disclose improvement methods for dynamically controlling both the contrast adjustment of the video signal and the luminance adjustment of the backlight with correlation therebetween, there are such methods, for example. According to the conventional improvement method disclosed in Patent Document 3, the dynamic range of the video signal is widened referring to the average luminance level. A level of the video signal is shifted depending on an offset. Because this causes a visual luminance level on a display screen to shift, the lighting of a backlight is controlled in order that the average luminance level at image display may be equivalent to the average luminance level of the video signal, so that the shift is absorbed by the light modulation of the backlight. These operations remedy a visual contrast feeling.

According to the conventional improvement method disclosed in Patent Document 4, both an amount of illumination light of the backlight and an amount of light extinction of the liquid crystal panel are controlled with weighting of the video signal in accordance with the average luminance level of the input video signal. That is, an image with high degree of freedom in expressions is provided by controlling the backlight and the liquid crystal panel in such a manner that the amount of illumination light of the backlight is increased in order to increase the luminance of the display image, whereas the amount of light attenuation of the liquid crystal panel is decreased. In addition, this improvement method provides an image whose variation range of the light intensity exceeds the dynamic range of the liquid crystal panel by controlling the backlight in such a manner that the amount of illumination light is decreased in order to decrease the luminance of the display image in the liquid crystal panel whose light attenuation is increased, or that the amount of illumination light is increased in order to increase the luminance of the display image in the liquid crystal panel whose light attenuation is decreased.

[Patent Document 1] Japanese Unexamined Patent Publication, Tokukaihei, No. 8-201812 (published on Aug. 9, 1996))

[Patent Document 2] Japanese Patent (No. 3495362 (issued on Feb. 9, 2004))

[Patent Document 3] Japanese Patent (No. 3215388 (issued on Oct. 2, 2001))

[Patent Document 4] Japanese Patent (No. 3513312 (issued on Mar. 31, 2004))

[Patent Document 5] Japanese Patent (No. 3583124 (issued on Oct. 27, 2004))

### DISCLOSURE OF INVENTION

There is a problem that the luminance control which is appropriate enough to the characteristics of the image cannot be performed in conventional arrangements such that the backlight is controlled in accordance with the average luminance level of the video signal, as described in the patent documents 1 to 4.

That is, the average luminance level of an image consisting of a darkest half-screen part and a brightest half-screen part is the same as that of a gray (50%) full-screen image. Accordingly, the luminance control of the backlight in accordance with the average luminance level is performed on each of the two types of images in the same way. However, the control according to each of the images should naturally differ because the image consisting of the darkest half-screen part and the brightest half-screen part, and the gray (50%) full-screen image are completely different in the characteristics of the images. Therefore, control according to each of the images naturally differs. Desired is an arrangement which makes it possible to perform the luminance control on such images, whose average luminance levels are the same, according to each image based on the characteristics thereof.

On the other hand, as Patent Document 2 describes, an arrangement such that the backlight is controlled based on the histogram distribution of the video signal makes it possible to extract the characteristics of the image which are not simply determined solely by the detected average luminance level. However, a conventional luminance control of a backlight utilizing histogram distribution requires complex processing and the large calculation amount for pattern recognition because the pattern of determined histogram distribution needs to be recognized through image processing.

In view of the problems, an object of the present invention is to provide an image display device which can perform, according to the characteristics of each image, appropriate control on the images on which the same control has been performed in the conventional luminance control utilizing the average luminance level and also appropriate control according to the characteristics of the image through a simpler processing in comparison with the conventional luminance control utilizing the histogram distribution.

In order to attain the object, an image display device of the present invention including a light source and a light modulation device which attenuates light from the light source in accordance with a video signal so as to change the luminance of a display image, the image display device, includes: weighting means for weighting luminance information of the video signal inputted thereto; image characteristic value determining means for determining an image characteristic value of one frame by taking by one frame an average of the luminance information weighted by the weighting means; and light source controlling means for performing luminance correction of the light source in accordance with the image characteristic value determined by the image characteristic value determining means.

According to this arrangement, the weighting means weights the luminance information of the inputted video signal; the image characteristic value determining means determines the image characteristic value by taking by one frame an average of the luminance information weighted by the weighting means; and the light source control means performs the luminance correction of the light source in accordance with the determined image characteristic value.

This makes it possible to perform luminance control according to the characteristics of each image because, in such a way, on the basis of the image characteristic values obtained by weighting the luminance information of the video signals and thereafter taking averages of the weighted luminance information, it is possible to distinguish even images which are indistinguishable from each other on the basis of the average luminance levels (APL) thereof, such as the image consisting of the darkest half-screen part and the brightest half-screen part, and the gray (50%) full-screen image.

That is, it is possible to distinguish differences between images which cannot be simply determined solely from the detected average luminance levels, not by the means for determining the histogram distribution and recognizing the distribution pattern thereof, but by a simple means for taking an average. This makes it possible to perform further effective luminance control according to the characteristics the images.

In order to solve the problems above, another image display device of the present invention is an image display device which displays an image of an inputted video signal on a light modulation device having a light source, including: histogram determining means for dividing luminance information of one frame of the inputted video signal into a plurality of luminance information classifications and determining histogram distribution of the luminance information classifications; weighting means for weighting the histogram distribution of the luminance information classifications, the histogram distribution being determined by the histogram determining means; image characteristic value determining means for determining an image characteristic value by taking an average of a result of the histogram distribution of the luminance information classifications, the histogram distribution being weighted by the weighting means; and light source controlling means for performing luminance correction of the light source in accordance with the image characteristic value determined by the image characteristic value determining means.

According to this arrangement, the histogram detecting means divides the luminance information of the inputted video signal into the plurality of luminance information classifications and determines the histogram distribution of the luminance information classifications; the weighting means weights the histogram distribution of the luminance information classifications, determined by the histogram detecting means; the image characteristic value determining means determines the image characteristic value by taking an average of the result of the weighted histogram distribution of the luminance information classifications; and the light source control means performs the luminance correction of the light source in accordance with the determined image characteristic value.

This makes it possible to perform luminance control according to the characteristics of each image because, in such a way, on the basis of the image characteristic values obtained by weighting the results of the histogram determination and thereafter taking averages thereof, it is possible to distinguish even images which are indistinguishable from each other on the basis of the average luminance levels (APL) thereof, such as the image consisting of the darkest half-screen part and the brightest half-screen part, and the gray (50%) full-screen image.

In addition, it is possible to distinguish differences between such images by a simple means for taking an average of the result of the histogram determination in comparison with the conventional arrangement such that the luminance control is performed through the recognition of a distribution pattern of the result of the histogram determination. This makes it possible to perform an effective luminance control according to the characteristics the images.

### BRIEF DESCRIPTION OF DRAWINGS

FIG. 1 is a block diagram of one embodiment of the present invention, illustrating a structure of a substantial part of an image display device.

FIG. 2 is a graph showing relation between a video signal level and an output of one function which a weighting section of the image display device uses for weighting a video signal.

FIG. 3 is a graph showing relation between a video signal level and an output of another function which the weighting section of the image display device uses for weighting a video signal.

FIG. 4 is a graph showing relation between a video signal level and an output of still another function which the weighting section of the image display device uses for weighting a video signal.

FIG. 5 is a graph showing relation between an image characteristic value and a backlight luminance in one arithmetic expression (or a table) which a backlight luminance determination section of the image display device uses for the determination of the backlight luminance.

FIG. 6 is a graph showing relation between an image characteristic value and a backlight luminance in another arithmetic expression (or a table) which the backlight luminance determination section of the image display device uses for the determination of the backlight luminance.

FIG. 7 is a graph showing relation between an image characteristic value and a backlight luminance in still another arithmetic expression (or a table) which the backlight luminance determination section of the image display device uses for the determination of the backlight luminance.

FIG. 8 is a graph showing relation between an image characteristic value and a backlight luminance in yet another arithmetic expression (or a table) which the backlight luminance determination section of the image display device uses for the determination of the backlight luminance.

FIG. 9 is a graph showing a functional capability of a temporal filter of the image display device.

FIG. 10 is one drawing of an example in which the weighting of a video signal is performed only on the luminance information corresponding to a specific area in a full screen.

FIG. 11(a) is another drawing of an example in which the weighting of a video signal is performed only on the luminance information corresponding to a specific area in the full screen.

FIG. 11(b) is still another drawing of an example in which the weighting of a video signal is performed only on the luminance information corresponding to a specific area in the full screen.

FIG. 11(c) is yet another drawing of an example in which the weighting of a video signal is performed only on the luminance information corresponding to a specific area in the full screen.

FIG. 12 is a block diagram of another embodiment of the present invention, illustrating a structure of a substantial part of an image display device.

FIG. 13 is a graph showing relation between an image characteristic value and a backlight luminance in an arithmetic expression (or a table) which a backlight luminance determination section of the image display device uses for the determination of the backlight luminance.

FIG. 14 is a block diagram of still another embodiment of the present invention, illustrating a structure of a substantial part of an image display device.

FIG. 15 is a histogram showing a histogram distribution of an example image determined by a histogram determination section of the image display device.

FIG. 16 is a table showing image characteristic values: the averages of the results which are the histogram distribution of FIG. 15 weighted by a weighting section, together with conventional average luminance levels as a comparative example.

FIG. 17(a) is a table showing image characteristic values: the averages of the results which are the histogram distribution, weighted by the weighting section, of an image consisting of a darkest half-screen part and a brightest half-screen part, together with the conventional average luminance levels as a comparative example.

FIG. 17(b) is a table showing image characteristic values: the averages of the results which are the histogram distribution, weighted by the weighting section, of a gray (50%) full-screen image, together with the conventional average luminance levels as a comparative example.

FIG. 18 is a block diagram of yet another embodiment of the present invention, illustrating a structure of a substantial part of an image display device.

FIG. 19 is a block diagram illustrating a structure of a substantial part of a conventional image display device.

### EXPLANATION OF NUMERALS

11 LCD panel (Light modulation device)
12 Backlight (Light source)
13 Backlight controlling section (Light source control means)
19 Weighting section (Weighting means)
20 Image characteristic value determination section (Image Characteristic Value Determining Means)
21 Backlight luminance determination section
22 Signal level correction section (Video signal level correction means)
23 Illuminance sensor

### BEST MODE FOR CARRYING OUT THE INVENTION

Embodiments of the present invention are described below with reference to the figures.

### Embodiment 1

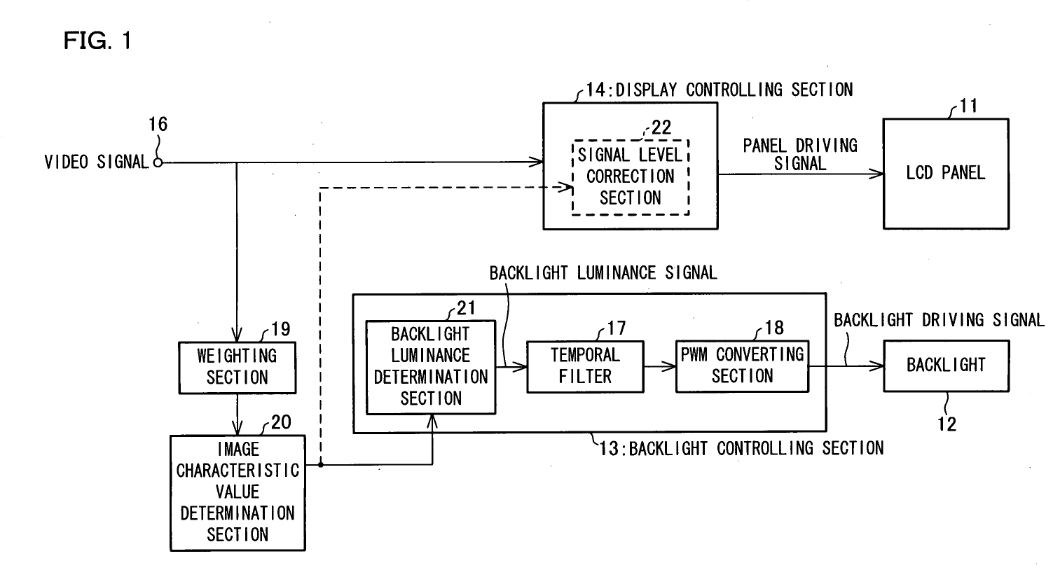

An image display device of Embodiment 1 of the present invention is described with reference to FIGS. 1 through 10, 11(a), 11(b), and 11(c).

FIG. 1 is a block diagram illustrating a structure of the image display device of Embodiment 1 of the present invention. As illustrated in FIG. 1, the image display device includes an LCD panel (a light modulation device) 11, a backlight (a light source) 12, a backlight controlling section (a light source controlling section) 13, a display controlling section 14, a weighting section (a weighting means) 19, an image characteristic value determination section (an image characteristic value determining means) 20, and an input 16.

A video signal to be displayed on the LCD panel 11 is inputted from the input 16 in the form of, for example, a YPbPr signal. The display controlling section 14 performs control in order to display the video signal on the LCD panel 11 and outputs the video signal to the LCD panel 11 as a panel driving signal. Specifically, operations such as the conversion of a YPbPr signal into an RGB signal, changing an order of video signals according to a driving method of the LCD panel 11, and the most suitable gamma correction for the LCD panel 11. A display mode of the LCD panel 11 is, for example, a vertical alignment mode.

The backlight 12 is a light source for the LCD panel 11 of a transmission-type to obtain screen luminance. The backlight 12 may be a cold-cathode tube, a hot-cathode tube, an LED, an electron-emission type flat surface source, or the like.

The backlight controlling section 13 outputs a backlight driving signal and thereby controls luminance of the backlight 12. The backlight controlling section 13 is provided with a backlight luminance determination section 21, a temporal filter 17, and a PWM converting section 18.

In accordance with an image characteristic value inputted from the image characteristic value determination section 20, the backlight luminance determination section 21, as described below, determines the luminance of the backlight 12 and outputs the luminance as a backlight luminance signal. The temporal filter 17 makes change of luminance of the backlight 12 gradual. The PWM converting section 18 outputs a backlight driving signal in accordance with the backlight luminance signal inputted from the backlight luminance determination section 21. By the provision of the temporal filter 17 between the backlight luminance determination section 21 and the PWM converting section, the occurrence of flickers can be avoided because the luminance of the backlight 12 changes slowly (through several frames) and gradually even if the backlight luminance signal drastically changes between adjacent frames of one video signal.

The weighting section 19 is for weighting the luminance information of an inputted video signal (hereafter an input video signal). Weighting is performed in such a manner that luminance information of higher luminance side is weighted relatively more than luminance information of lower luminance side.

The image characteristic value determination section 20 is for, by a frame, accumulating the luminance information weighted by the weighting section 19 and taking an average thereof (an image characteristic value). The backlight controlling section 13 performs luminance control (luminance correction) of the backlight 12 in accordance with the image characteristic value determined by the image characteristic value determination section 20.

The image display device of the present invention is characterized in that the luminance information of the input video signal is weighed and the weighted luminance information is averaged to find an average value thereof as the image characteristic value, and the luminance of the backlight 12 is determined in accordance with the image characteristic value. The luminance control on the backlight 12 is described below in detail.

The weighting section 19 performs weighting calculation on the luminance information of all the pixels in one frame of an input video signal (corresponding to pixel values). A weighted value is a function of the luminance information of an input video signal. Because the luminance information of a video signal is expressed as a signal level, the function of luminance information is a function of the signal level of a video signal.

As described, in accordance with the signal level indicating the luminance information of each pixel which constitutes the input video signal, the weighting is performed, in a case of a high signal level (luminance information is high: bright), with a heavier weight than in a case of a low signal level (luminance information is low: dark). In other words, in accordance with the signal level of the input video signal, a lighter weight is used in the case of the low signal level for dark than in the case of the high signal level for bright.

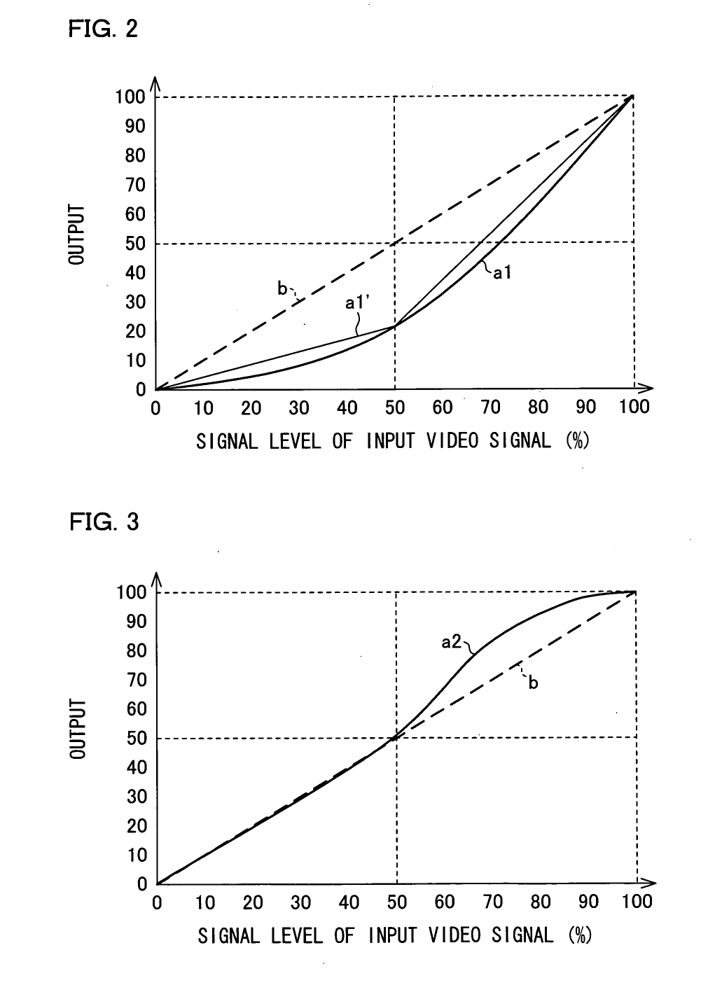

FIGS. 2 through 4 are graphs of functions used by the weighting section 19 for weighting input video signals. The horizontal axes of FIGS. 2 through 4 represent signal levels of an input video signal. A signal level of an input video signal is expressed in percentage. A signal level is 0% in the case of a black pixel whose pixel value of an input video signal is the lowest. A signal level is 100% in the case of a white pixel whose pixel value of an input video signal is the highest. On the other hand, the vertical axes of FIGS. 2 through 4 represent outputs: weighted pixel values of input video signals. An output is expressed by a value between 0 and 100. An output is 0 in the case of a signal level of an input video signal is 0%. An output is 100 in the case of a signal level of an input video signal is 100%.

In FIGS. 2 through 4, lines b represented by dashed lines represent a conventional function for taking an average of a signal level of an input video signal as it is. On the other hand, in FIGS. 2 through 4, curved lines a1 through a3 represented by continuous lines are graphs of functions (three types) used by the weighting section 19.

The curved line a1 shown in FIG. 2 represents a function plotting a line which is curved downward in relation to the line b over the whole range of signal levels between 0% and 100%. Assume an inflexion point is set to signal level 50%. Within a range equal to or less than signal level 50%, an output is gradually increased up to 25 (½ of signal level 50%) while suppressing the increase of the output in relation to the increase of a signal level. In a range more than signal level 50%, the output is increased in order that the output may be 100 at signal level 100% raising the ratio of the increase of output to the increase of the signal level.

Although the curved line a1 is described here, a function such as a broken line a1′ represented by a continuous line in FIG. 2 may be used for the curved line a1 instead. A formula representing the broken line a1′ is as below.

K=0.5×Y (Signal level of input video signal ≦50%)

K=1.5×Y−50 (Signal level of input video signal >50%)

Y: Signal level of input video signal (%)

K: Output

The curved line a2 shown in FIG. 3 is nearly a straight line having the same gradient as the line b in a range of signal level between 0% and 45%. The curved line a2 is a function plotting a line which is curved upward in relation to the line b in the range of signal level between 45% and 100%. An output is equal to a signal level in a range between signal levels 0% and 45%. In a range above signal level 45%, an output is gradually raised to a bigger value than a signal level and approximated to 100 earlier than the line b.

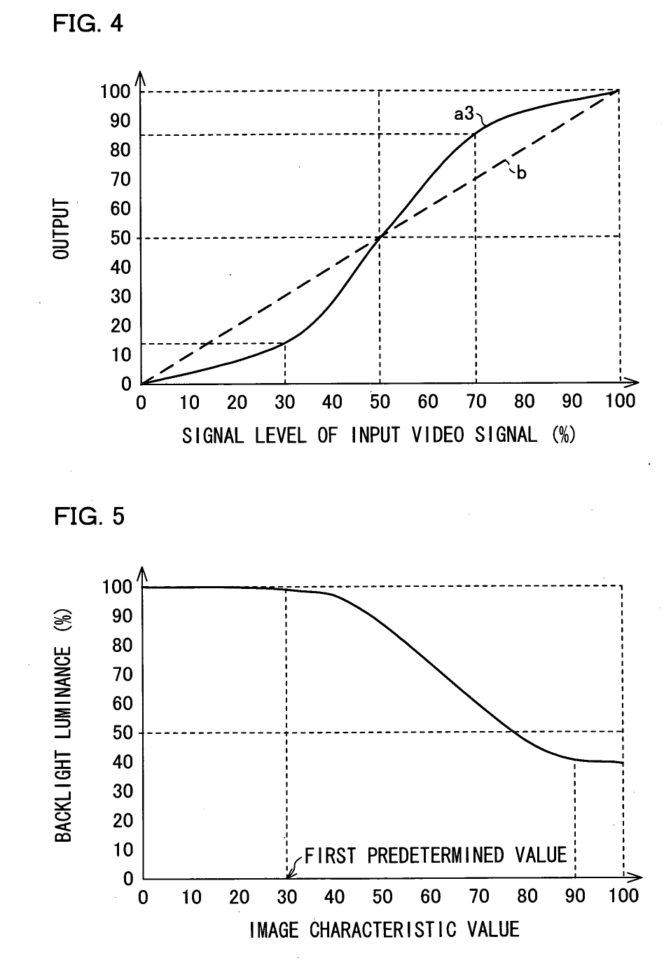

The curved line a3 in FIG. 4 represents a function plotting a line which is, in relation to the line b, curved downward in a range between signal levels 0% and 50% and curved upward in a range more than signal level 50%. When an inflexion point is set to signal level 30%, within a range less than signal level 30%, an output is gradually raised up to ½ of signal level suppressing the increase of the output in relation to the increase of the signal level. In a range equal to or more than signal level 30%, the output is raised at once in order that the output may be 50 at signal level 50%. An inflexion point is set to signal level 70% in a range of signal level more than 50%. An output is raised up to 85 at once in a range of signal level between 50% and 70%. In a range of signal level more than 70%, the output is gradually approximated to 100 while suppressing the increase of the output in relation to the increase of the signal level.

The image characteristic value determination section 20 takes an average of an output inputted from the weighting section 19. An image characteristic value of one frame is calculated here in such a manner that outputs of one frame are accumulated and the accumulated result is divided by the number of total pixels on a display screen. As well as an output, an image characteristic value is expressed by a value between 1 and 100.

Although average luminance levels (APL) of an image consisting of the darkest half-screen part and the brightest half-screen part, and a gray (50%) full-screen image are the same, a difference between the image characteristic values thereof makes it possible to distinguish the images from each other because the image characteristic values found after weighting the luminance information of video signals are not the same.

The backlight luminance determination section 21 in the backlight controlling section 13 determines the luminance of the backlight 12 in accordance with an image characteristic value inputted from the image characteristic value determination section 20 and outputs the luminance as a backlight luminance signal. The backlight luminance determination section 21 is provided with formulas which represent the relations between an image characteristic value and the luminance of the backlight 12 as in FIGS. 5 through 7 or tables, which represents the relations. With the use of the formula or the table, the backlight luminance determination section 21 determines the luminance of the backlight of the backlight 12 in accordance with an image characteristic value inputted from the image characteristic value determination section 20.

The horizontal axes in FIGS. 5 through 7 represent the image characteristic values inputted from the image characteristic value determination section 20, in other words, averages each of which is the quotient worked out by dividing, by the number of total pixels on a display screen, accumulation of outputs outputted from the weighting section 19 per one frame. On the other hand, the vertical axes in FIGS. 5 through 7 represent the luminance of the backlight 12 which is outputted to the backlight controlling section 13 as a backlight luminance signal. The luminance of the backlight 12 which is expressed in percentage is 100% in the brightest state that the amount of illumination light is the largest whereas the luminance is 0% in the OFF state that the amount of illumination light is zero.

In the relation in FIG. 5, a luminance of a backlight is kept at 100% while an image characteristic value increases from 0 to the first predetermined value (i.e. image characteristic value 30 in FIG. 5). After the image characteristic value surpasses the first predetermined value, the luminance is lowered from 100% to, at image characteristic value 90, around 40%. In the range more than image characteristic value 90, the luminance is kept at 40% nearly constant.

With a formula or a table representing such a relation, the luminance of the backlight 12 is lowered at the image display of a bright image such that the most part of a display screen is displayed white. Thereby, it is possible to prevent giving a user a feeling of an image to be too bright, or to make it difficult to give him such a feeling. In addition, the reduction of power consumption is realized.

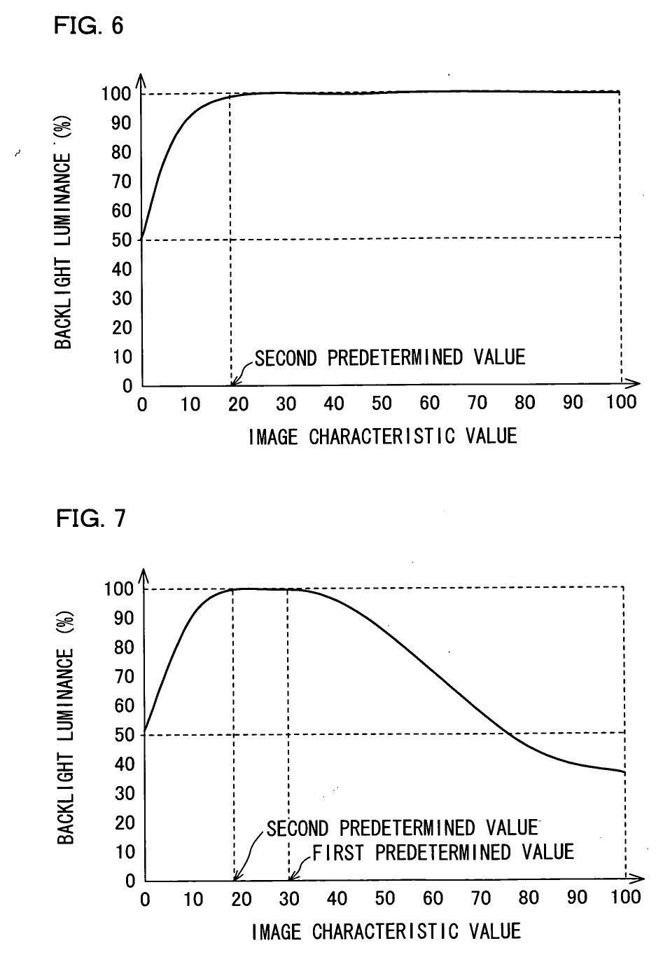

In the relation in FIG. 6, a luminance of the backlight is raised from 50% to 100% while an image characteristic value increases from 0 to the second predetermined value (i.e. image characteristic value 17 in FIG. 6). In the range of image characteristic value more than the second predetermined value, the luminance is kept at 100%.

With a formula or a table representing such a relation, lowering the luminance of the backlight 12 makes it possible to avoid power consumption for unnecessary emission of light at the image display of a dark image such that the most part of a display screen is black and remedy the problem of a graying of black level due to the light leakage of the backlight 12 from a black display screen part.

The relation in FIG. 7 is such that the relations in FIGS. 5 and 6 are combined. A luminance of the backlight is raised from 50% to 100% while an image characteristic value increases from 0 to the second predetermined value (i.e. image characteristic value 17 in FIG. 7). The luminance is kept at 100% until the image characteristic value surpasses the first predetermined value (i.e. image characteristic value 30 in FIG. 7) in the range of image characteristic value more than the second predetermined value. After the image characteristic value surpasses the first predetermined value, the luminance is lowered from 100%.

With a formula or a table representing such a relation, because the luminance of the backlight 12 is lowered at the image display of a dark image such that the most part of a display screen is displayed black and the image display of a bright image such that the most part of a display screen is displayed white, it is possible to avoid power consumption for unnecessary emission of light and remedy the problem of a graying of black level in a black display screen part and the problem of a too bright image in a case where a white display screen part is large.

The first and the second predetermined values are preferably set to an image characteristic value between 10 and 30. The first and the second predetermined values may be the same (the first predetermined value ≧ the second predetermined value).

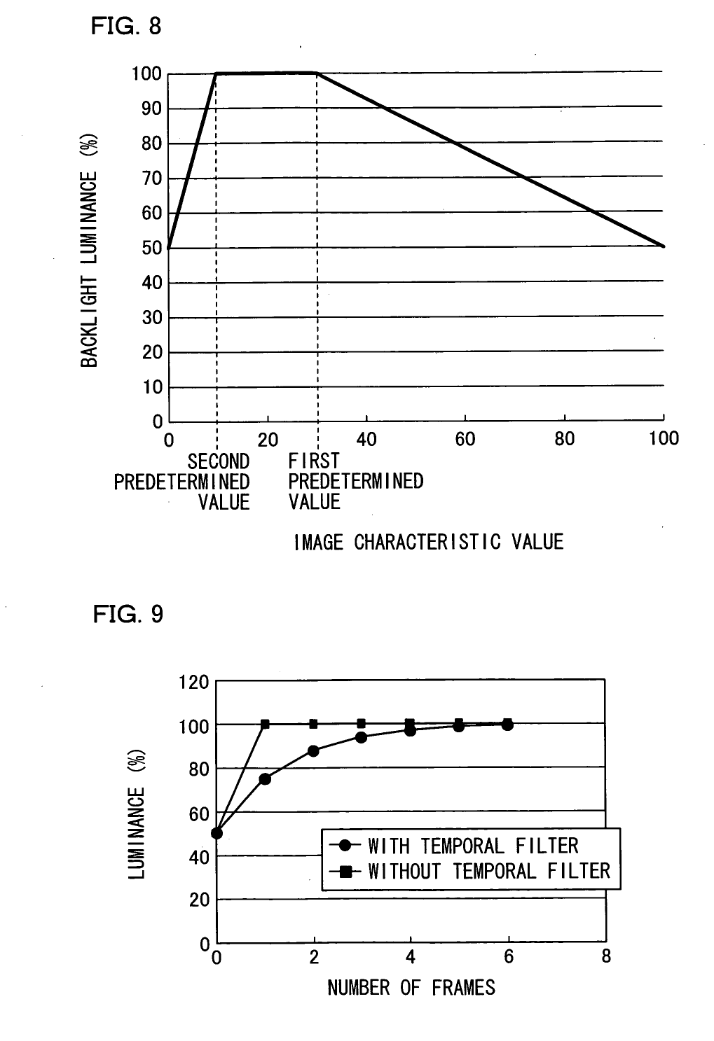

In the relations in FIGS. 5 through 7, the luminance of the backlight 12 is changed to draw a curve. However, the relations may be linear as in FIG. 8. In FIG. 8, the first predetermined value is set to 30; The second predetermined value is set to 10.

The backlight luminance determined in such a way by the backlight luminance determination section 21 is outputted as a backlight luminance signal. The backlight luminance signal is inputted into the PWM converting section 18 via the temporal filter 17.

FIG. 9 illustrates an example in which the temporal filter 17 makes the luminance of the backlight 12 smoothly change. In this example, it takes 6 frames in order to change the luminance of the backlight 12 from the current 50% to the next target 100%. Specifically, an average of a value of a current frame and a target value is taken and set as a value of the next frame. By repeating this operation six times, a value reaches the target value in the sixth frame. Thus, by taking an average of a previous and a target values, the change of the luminance becomes accompanied by temporal delay.

In the example of FIG. 9, an average of a previous and a target values which are equally weighted is taken. By changing the weighting, the temporal delay can be controlled. That is, taking an average of a previous and a target values with weighting makes it possible to control the number of frames required to achieve a target value.

As described above, in the image display device of the present embodiment, the weighting section 19 weights the luminance information of an input video signal; the image characteristic value determination section 20 takes an average of weighted luminance information by every frame and determines an image characteristic value of one frame; and the backlight controlling section 13 performs luminance correction of the backlight 12 in accordance with the determined image characteristic value.

In this arrangement, not by a means in which histogram distribution is determined and the distribution pattern thereof is recognized, but by a simple means in which an average is taken, it is possible to distinguish differences between images which cannot be simply determined solely from the detected average luminance level and perform more effective luminance control according to characteristics of an image.

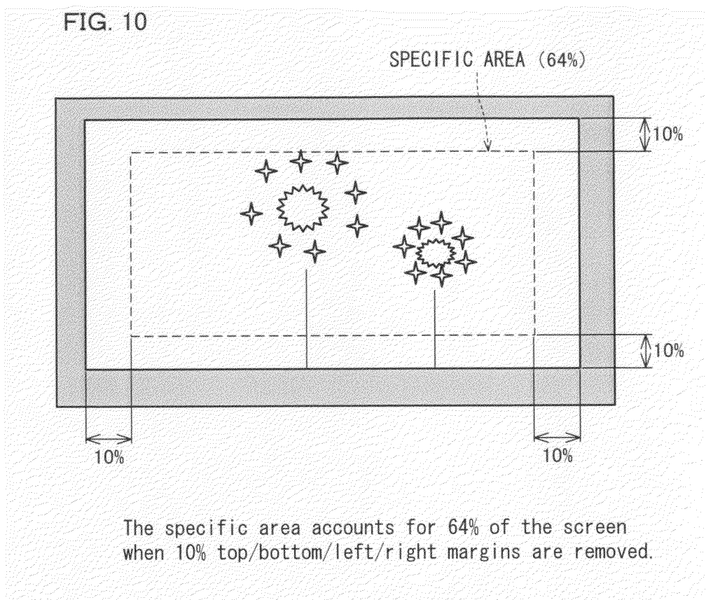

As for an area in which the weighting section 19 weights the luminance information of an input video signal, it may be arranged such that, as in FIG. 10 for example, only the luminance information corresponding to a specific area in a full screen is weighted although the luminance information of all the pixels of one frame of an input video signal in the full screen of the LCD panel 11 is weighted above.

In the arrangement of FIG. 10, only the luminance information corresponding to the central area of the display screen except the 10% (dimensional ratio) top/bottom/left/right margins. In this case, the specific area accounts for 64% of the full screen. In a case where a specific area at the center of the screen is weighed, weighing an area accounting for 50%-70% as in FIG. 10 is effective in order to make an effective contribution to image display.

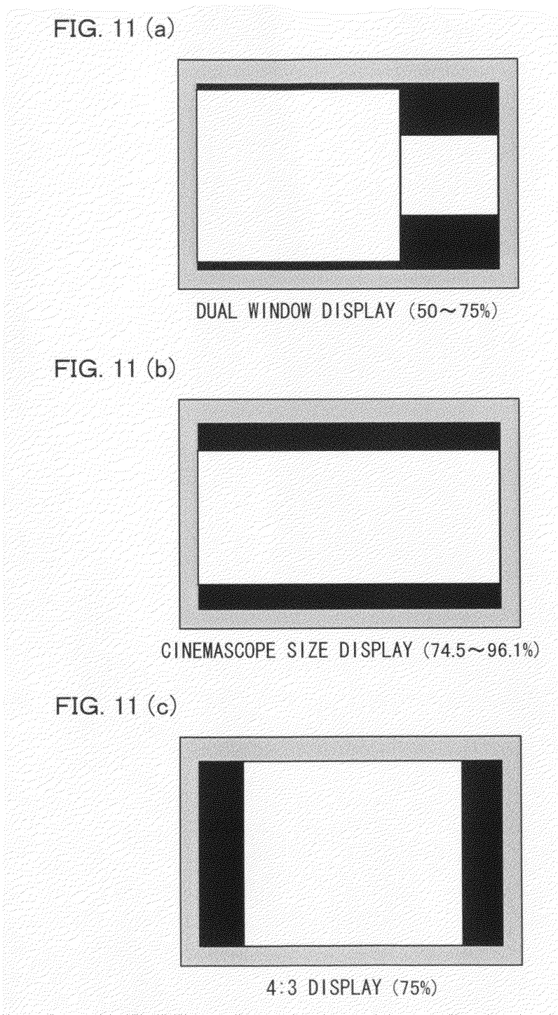

In the case of, for example, dual window display as in FIG. 11(a), the area of the main window (area ratio 50%-75%) in the two windows is preferably specified as a specific area. In the case of Cinema Scope size display, the display area (area ratio 74.5%-96.1%) is preferably specified as a specific area. Also, in the case of image display of a 4:3 image as in FIG. 11(c) on a 16:9 display screen with the aspect ratio of the image retained, the display area (area ratio 75%) is preferably specified as a specific area. That is, it is preferably arranged such that a target domain for determining an image characteristic value is variable depending on a video source and a display mode.

In a case where a specific area in a full screen is a target domain for weighting, the image characteristic value determination section 20 in the following stage determines an average by dividing the accumulation of outputs from the weighting section 19 by the number of pixels in a specific area, needless to say.

In the image display device of the present embodiment, as described, the display controlling section 14 does not use an image characteristic value determined by the image characteristic value determination section 20 at outputting an input video signal as a panel driving signal to the LCD panel 11. However, in an arrangement such that utilizing a table which defines a relation as shown in FIGS. 6 through 8, the backlight luminance determination section 21 lowers (less than 100%) the luminance of the backlight 12 if an image characteristic value inputted by the image characteristic value determination section 20 is equal to or less than the second predetermined value, the arrangement may be such that the luminance of the backlight 12 is lowered and a signal level is corrected in order that the signal level of a video signal may be raised.

As represented by a dashed line in FIG. 1, such an arrangement is realized by providing further a signal level correction section (a video signal level correcting means) 22 to the display controlling section 14. A determined image characteristic value is inputted into the signal level correction section 22 from the image characteristic value determination section 20. The signal level correction section 22 corrects a signal level in accordance with an inputted image characteristic value in order that the signal level of a video signal may rise in the case of the decrease of the luminance of the backlight 12.

Because of this, decrease of a screen luminance is restrained by the raise of a signal level of an input video signal even if the luminance of the backlight 12 decreases. As a result, an influence due to decrease of the luminance of the backlight 12 hardly appears on a display screen.

In such an arrangement that the luminance of the backlight 12 is lowered and a signal level of the input video signal is raised by the display controlling section 14 when an image characteristic value inputted from the image characteristic value determination section 20 is equal to or less than the second predetermined value, it is preferable that, when the image characteristic value is equal to or less than the second predetermined value, a peak luminance level or an average luminance level is set to an almost same level between both cases where there is no correction to both the backlight 12 and the input video signal and where there is no correction thereto. This makes it possible to prevent more effectively the influence due to the decrease of the luminance of the backlight 12 from appearing in a screen display.

### Embodiment 2

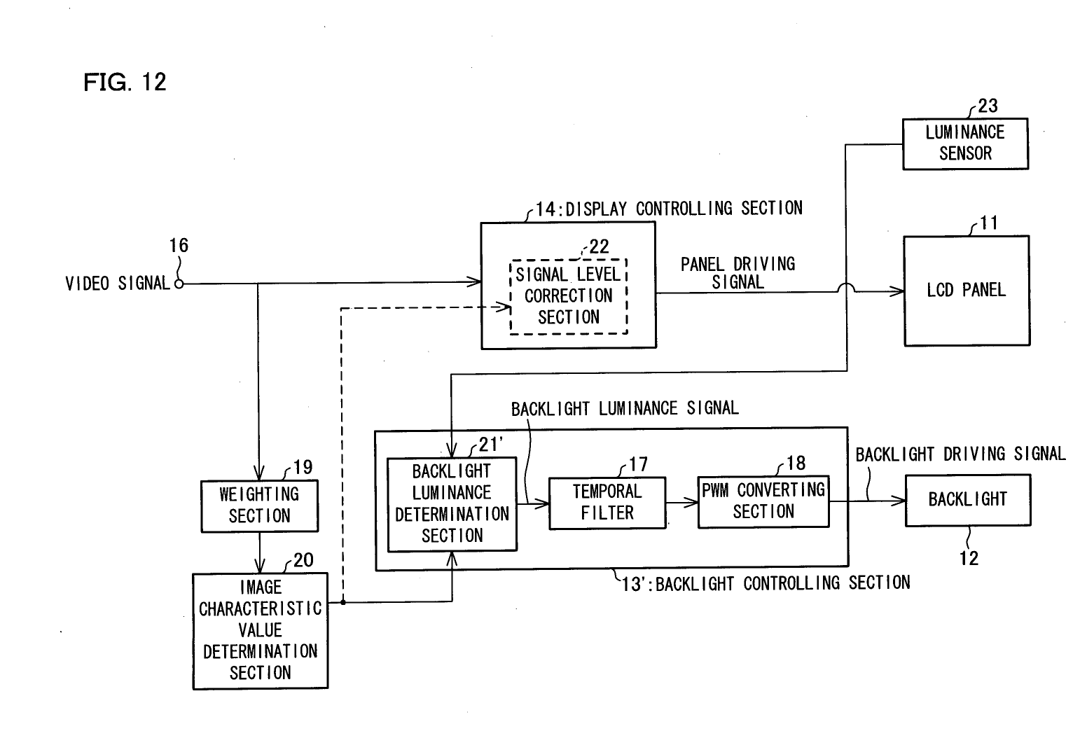

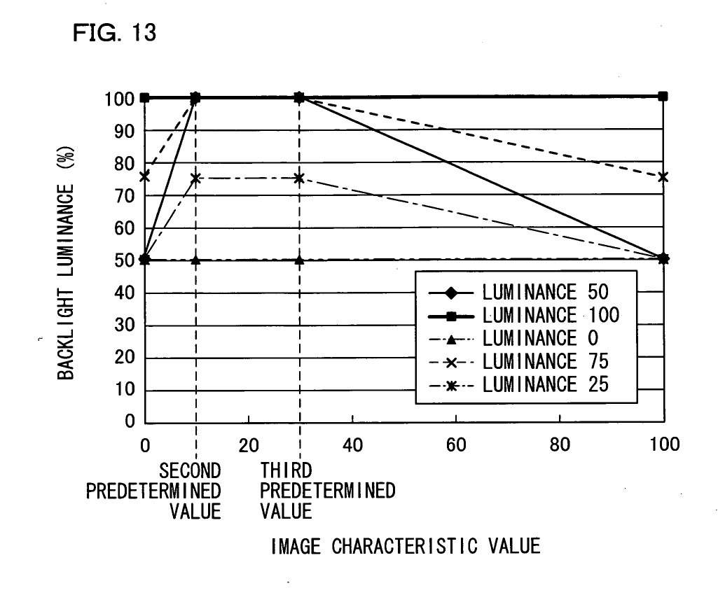

An image display device of Embodiment 2 of the present invention is described below with reference to FIGS. 12 and 13. For the sake of simplicity, members with same functions as those of members of Embodiment 1 are given the same symbols and descriptions for the members are omitted.

FIG. 12 is a block diagram of a structure of the image display device of Embodiment 2 of the present invention. As illustrated in FIG. 12, the image display device additionally includes a luminance sensor 23 whose measurement output is inputted into a backlight luminance determination section 21′ in a backlight controlling section 13′. The backlight controlling section 13′ is different from the backlight controlling section 13 only in that the backlight controlling section 13′ includes the backlight luminance determination section 21′ instead of the backlight luminance determination section 21.

The luminance sensor 23 is for the measurement of luminance around the image display device. A measurement output of the luminance sensor 23 is between luminance 0 and 100. A luminance of the very dark vicinity of the image display device is 0 whereas a luminance of the very bright vicinity of the image display device is 100.

The backlight luminance determination section 21′ takes into account the measurement output which is inputted from the luminance sensor 23 in order to determine the luminance of the backlight 12 in accordance with an image characteristic value inputted from the image characteristic value determination section 20. Only this is the difference between the backlight luminance determination section 21′ and the backlight luminance determination section 21.

The backlight luminance determination section 21′, as in FIG. 13, includes a plurality of formulas or a plurality of tables, so that a formula or table most suitable for certain illuminance can be used for the illuminance. The formulas or tables show the relationship between the image characteristic values and the luminance of the backlight 12. The backlight luminance determination section 21′ selects a formula or a table according to luminance and thereby determines the luminance of the backlight 12.

In FIG. 13, when luminance which is a measurement output of the luminance sensor 23 is 50, the backlight luminance determination section 21′ uses a formula or a table whose relation between an image characteristic value and the luminance of the backlight 12 is the same as that in FIG. 8. On the other hand, when luminance is 100, the luminance of the backlight 12 is constantly kept at 100%. When luminance is 0, on the other hand, the luminance of the backlight 12 is constantly kept at 50%. Between luminance 50 and 100, the minimum luminance of the backlight 12 is raised according to luminance; between luminance 0 and 50, the maximum luminance of the backlight 12 is lowered according to luminance.

In a case, for example, where the vicinity of the image display device is very bright, even a bright image which is largely displayed white is unclear to see due to the luminance of the vicinity with the decrease of the luminance of the backlight 12 and the decrease of screen luminance thereby. The arrangement makes it possible to prevent such a case of an unclear image due to the decrease of screen luminance because there is no or small decrease of the luminance of the backlight 12 according to the luminance thereof when the vicinity of the image display device is bright.

On the other hand, in the case of the very dark vicinity of the image display device, a white display screen part tends to be perceived to be too bright. In addition, a graying of black level in a black display screen part tends to be also noticeable. In this arrangement, a too bright image and a noticeable graying of black level can be avoided in a case where the vicinity of the image display device is dark because, according to the darkness, the luminance of the backlight 12 is lowered independently of images or the peak luminance of the backlight 12 is lowered. Besides, more efficient power saving is realized.

### Embodiment 3

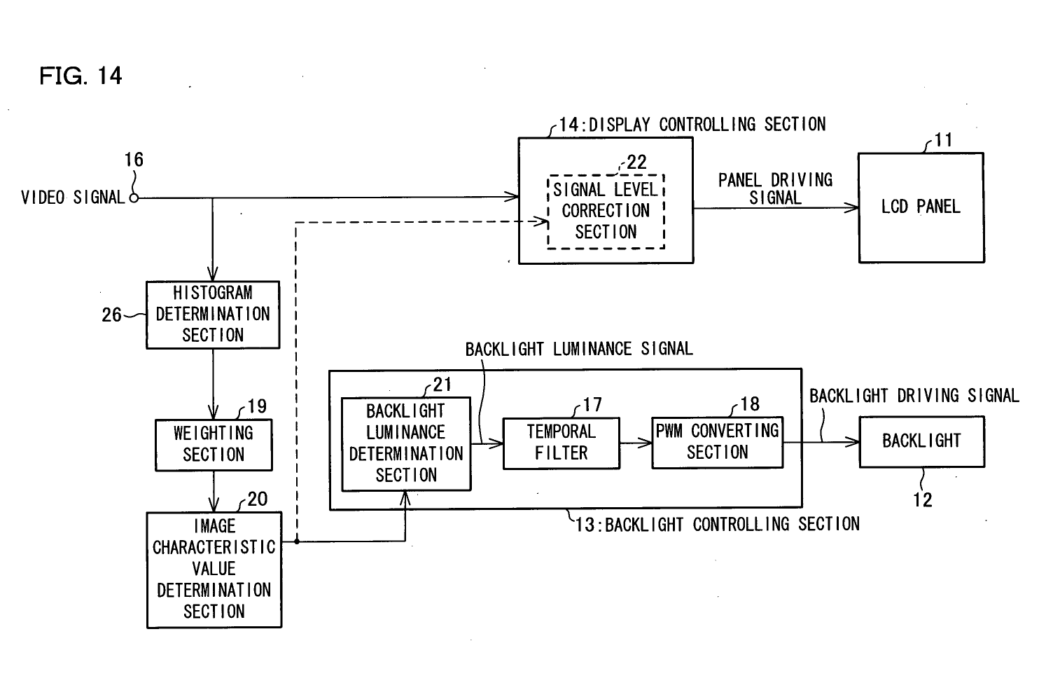

An image display device of Embodiment 3 of the present invention is described below with reference to FIGS. 14 through 16, FIG. 17(a), and FIG. 17(b). For the sake of simplicity, members with same functions as those of members of Embodiments 1 and 2 are given the same symbols and descriptions for the members are omitted.

FIG. 14 is a block diagram of a structure of the image display device of Embodiment 3 of the present invention. As in FIG. 14, the image display device additionally includes a histogram determination section (a means for determining histograms) 26. A histogram determination output determined by the histogram determination section 26 is inputted into the weighting section 19.

The histogram determination section 26 is for dividing luminance information of one frame of an input video signal (a pixel value) into a plurality of luminance information classifications and determining histogram distribution corresponding to each luminance information classification. The histogram determination section 26 classifies a signal level indicating the luminance information of all the pixels in one frame of an input video signal into classifications of level and determines histogram distribution therewith.

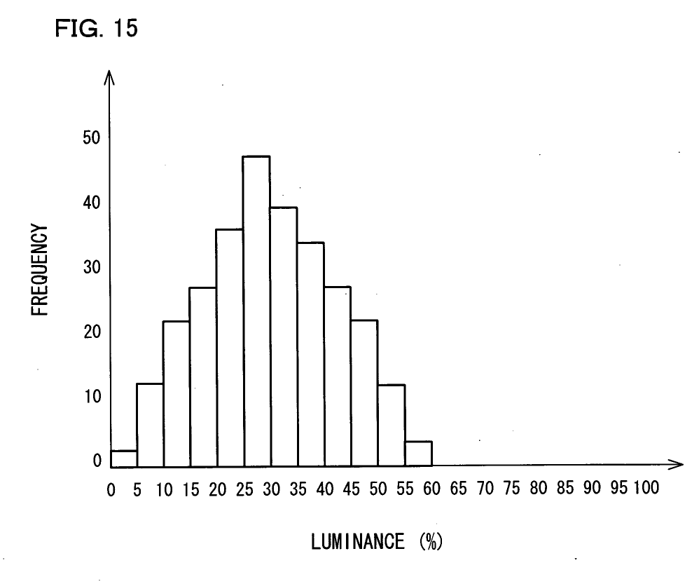

FIG. 15 shows an example of determined histogram distribution of one frame of an image (276 pixels). In FIG. 15, the luminance information of an input video signal (This is equivalent to the signal level) between 0 and 100% is, by 5%, classified into 20 classifications of level in total.

The weighting section 19, as stated, weights determined histogram distribution with the function. The image characteristic value determination section 20 accumulates outputs of the weighting section 19 and divides the accumulated outputs by the number of all the pixels (a total of frequencies) in order to calculate an average, i.e., an image characteristic value.

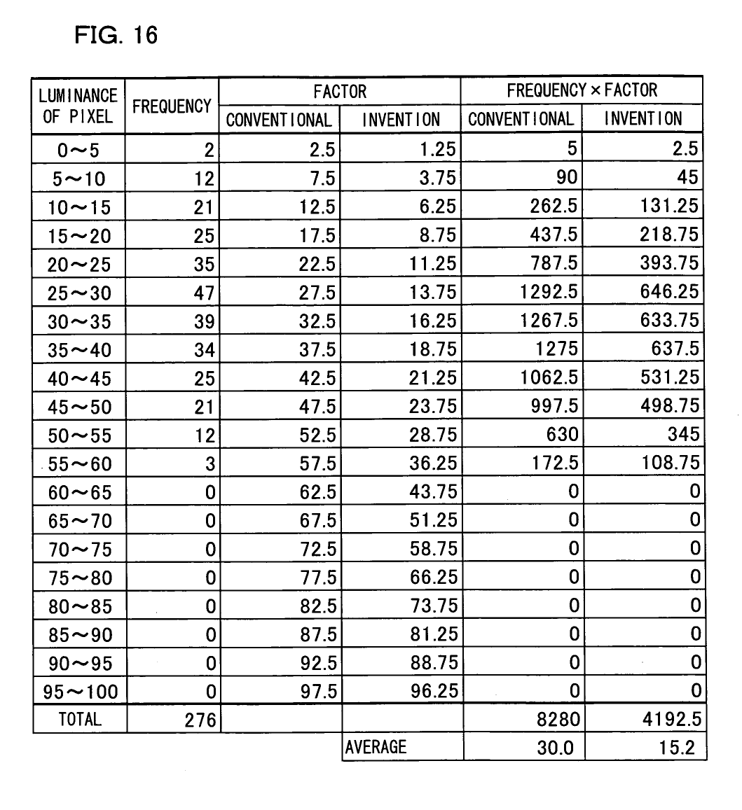

FIG. 16 shows results which are the averages calculated on the basis of weighted histogram distribution of FIG. 15. Factors in FIG. 16 are the factors of the functions used by the weighting section 19. In the conventional cases without weighting, a median of each classification of luminance value is the factor of the classification. In the classifications in which the luminance values are equal to or less than 50, the factor of the present invention is one half of a conventional factor whereas, in the classifications in which the luminance values are more than 50, the factor is a value which is 1.5 times of the conventional factor minus 50.

That is, the conventional factor Y and the factor of the present invention K are represented as below.

K=0.5×Y (Luminance value ≦50%)

K=1.5×Y−50 (Luminance value >50%)

As shown in FIG. 16, an average (an average luminance value) calculated on the basis of histogram distribution without weighting is 30.0. In contrast, an image characteristic value which is an average of weighted histogram distribution is 15.2. Thus, the weighting on histogram distribution makes it possible to make a difference between the averages.

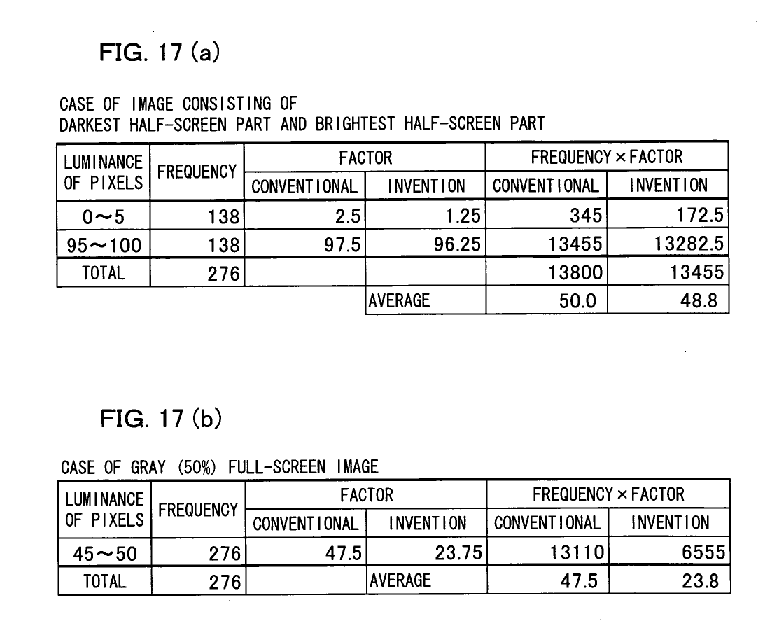

A case of another image consisting of the darkest half-screen part and the brightest half-screen part is described below. As shown in FIG. 17(a), with regard to frequency distribution of such an image, each half the number of pixels: 138 is included in the classification of level 0 to 5 and the classification of level 95 to 100 respectively. As a result of calculation of an average based on this, without weighting, the average luminance value is 50. The image characteristic value of the image display device which performs weighting is 48.8.

A case of a gray (50%) full-screen image is described below. As shown in FIG. 17(b), with regard to frequency distribution of such an image, the number of all the pixels 276 is included in the classification of level 45 to 50. As a result of calculation of an average based on this, without weighting, the average luminance value is 47.5. The image characteristic value of the image display device which performs weighting is 23.8.

Thus, the weighting makes a big difference between the average luminance value and the image characteristic value and thereby makes it possible to easily distinguish even images which are difficult to distinguish from each other based on average luminance values thereof due to almost the same average luminance values, such as the image consisting of the darkest half-screen part and the brightest half-screen part, and the gray (50%) full-screen image.

Therefore, appropriate luminance control according to characteristics of an image can be performed with characteristics of the image extracted through a simple processing in which weighting is performed on histogram distribution and taking an average of the result of the weighting without performing pattern recognition on determined histogram distribution through image processing as in a conventional manner.

It may be arranged such that a weighted value used by the weighting section 19 is switched to a more appropriate value according to the state of determined histogram distribution. Switching the weighted value enables more appropriate control according to characteristics of an image.

For example, widths of histogram distributions are different between the two cases above. Contrast of an image is very high when the width of histogram distribution is wide as in the case of the image consisting of the darkest half-screen part and the brightest half-screen part. On the other hand, contrast of an image is very low when histogram distribution concentrates on a narrow range as in the case of the gray (50%) full-screen image.

Therefore, it becomes possible to adjust the luminance of the backlight 12 more appropriate to characteristics of an image by the determination of contrast of the image according to the width of histogram distribution and the switching of the weighting value in order to perform luminance control according to the contrast of the image.

As shown in FIGS. 6 and 7, the backlight luminance determination section 21 performs luminance correction in order that the luminance of the backlight 12 may decrease when the image characteristic value is equal to or less than the second predetermined value only in a case where the number of pixels in the luminance information classification whose luminance information is equal to or more than a predetermined luminance information of determined histogram distribution is equal to or less than a predetermined value.

For example, in the case of an image such that the most part of a display screen displays black and a part thereof displays white, characteristics of the image can be determined with histogram distribution. Therefore, in the case of an image such that the most part of the display screen is black and a part thereof is white, by not lowering the luminance of the backlight 12, it is possible to effectively avoid a problem in that the screen luminance of the white display screen part decreases due to an effect of the decrease of the luminance of the backlight 12.

### Embodiment 4

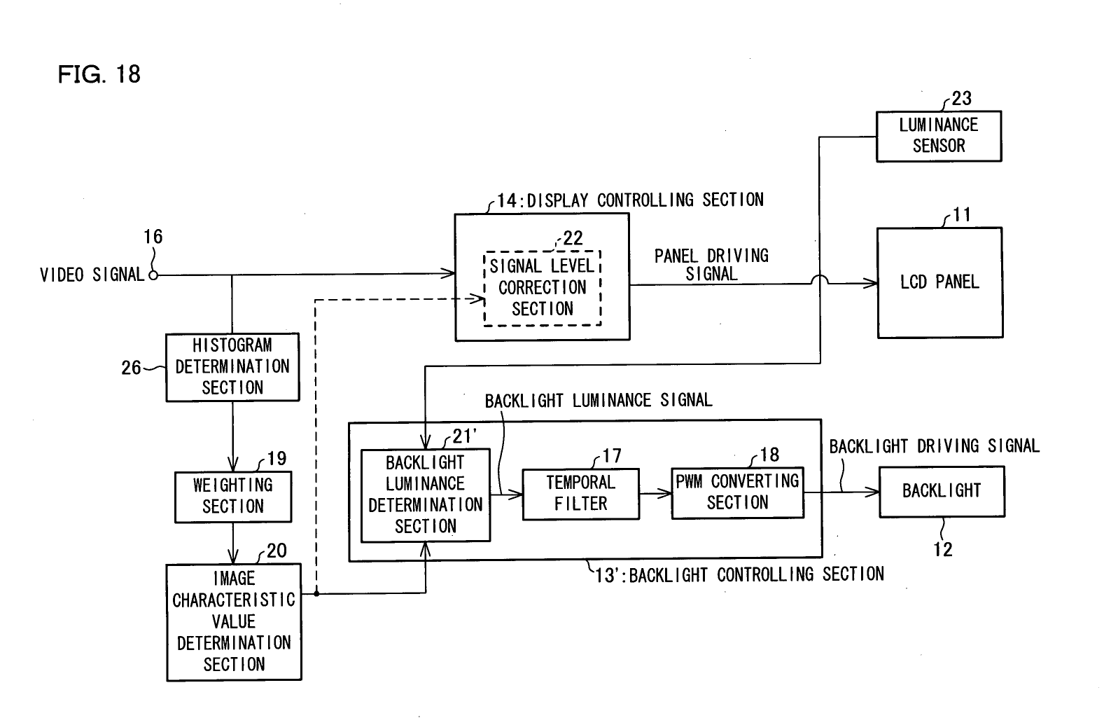

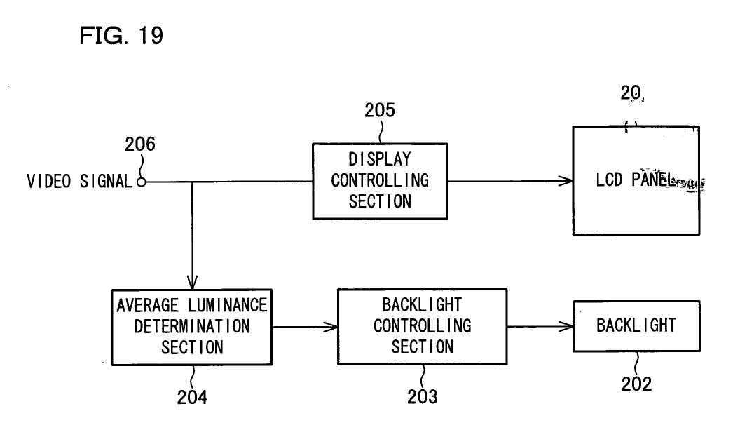

An image display device of Embodiment 4 of the present invention is described with reference to FIG. 18. For the sake of simplicity, members with same functions as those of members of Embodiments 1 through 3 are given the same symbols and descriptions for the members are omitted.

FIG. 18 is a block diagram of a structure of the image display device of Embodiment 4 of the present invention. As illustrated in FIG. 18, the image display device of the present embodiment is different from that of Embodiment 3 only in that the image display device of the present embodiment additionally includes the luminance sensor 23. An measurement output of the luminance sensor 23 is, as described for the image display device of Embodiment 2, inputted into the backlight luminance determination section 21′ in the backlight controlling section 13′.

This arrangement makes it possible to perform more appropriate luminance correction because luminance correction of a light source taking into account the luminance in the vicinity of the image display device can be performed as well as the image display device of Embodiment 2.

The image display device of the present invention may be arranged such that the weighting means performs weighting, for example, by using a function of the luminance information of the inputted video signal.

The image display device of the present invention may be further arranged such that the weighting means uses a function of the luminance information of the inputted video signal and selects the function according to the histogram distribution of the luminance information classifications, the histogram distribution being determined by the histogram determining means. Shifting the weighting value enables more appropriate control according to characteristics of an image.

The image display device of the present invention may be further arranged such that the weighting means performs weighting in such a manner that luminance information of higher luminance side is weighted relatively more than luminance information of lower luminance side. Such weighting makes it possible to efficiently differentiate images which are difficult to differentiate based on the average luminance levels (APL) thereof.

The image display device of the present invention may be further arranged such that the light source controlling means performs such luminance correction that the luminance of the light source is decreased when the image characteristic value determined by the image characteristic value determining means is equal to or more than the first predetermined value.

The luminance of the light source is lowered when displaying a bright image that the most part of a display screen is white. This makes it hard or impossible to give a user such a feeling that an image to be too bright. In addition, the power consumption can be reduced.

The image display device of the present invention may be further arranged such that the light source controlling means performs such luminance correction that the luminance of the light source is decreased when the image characteristic value determined by the image characteristic value determining means is equal to or less than the second predetermined value.

According to this arrangement, at the image display of a dark image such that the most part of a display screen is black, lowering the luminance of the light source makes it possible to avoid power consumption due to unnecessary emission of light and remedy the problem of a graying of black level due to the leakage of the light of the light source from a black display screen part.

The image display device of the present invention may be further arranged such that the light source controlling means performs such luminance correction that the luminance of the light source is decreased when the image characteristic value determined by the image characteristic value determining means is equal to or less than the second predetermined value in a case where the number of pixels in the luminance information classifications whose luminance information is equal to or more than predetermined luminance information in the histogram distribution corresponding to each luminance information classification determined by the histogram determining means is equal to or less than a predetermined value.

For example, in the case of such an image that the most part of a display screen is black and a part thereof is a white display screen part, a viewer would feel the image to be unclear due to the decrease of screen luminance in the white display screen part affected by the decrease of the luminance of the light source. With this arrangement, such a problem is avoided because the light source controlling means does not perform the decrease of the luminance of the light source with extraction of characteristic of such an image.

The image display device of the present invention may further include: a video signal level correction means for correcting a signal level of a video signal in such a manner that the signal level is raised, the video signal being inputted thereto and being to be supplied to the light modulation device, the light source controlling means performing the luminance correction of the light source in such a manner that the luminance of the light source is decreased, and the video signal level correction means performing the correction of the signal level in such a manner that the signal level of the video signal is raised.

For example, in the case of an image such that the most part of a display screen is black and a part thereof is a white display screen part, a viewer would feel the image to be unclear due to the decrease of screen luminance in the white display screen part affected by the decrease of the luminance of the light source. With this arrangement, such a problem is avoided because a signal level of an input video signal is raised even if the luminance of the light source is lowered. In this case, specifically, it is possible to more effectively prevent an influence of the decrease of the luminance of the light source to be displayed on a display screen by performing the luminance correction and the correction to the signal level in order that a peak luminance level or an average luminance level of the light modulation device may be constant before and after the luminance correction of the light source and the correction to the signal level of the video signal.

The image display device of the present invention may further includes: a luminance sensor for detecting luminance in the vicinity of the image display device, the light source controlling means changing degree of the correction in accordance with an output of the luminance sensor.

This makes it possible to perform more appropriate luminance correction because luminance correction of the light source taking into account the luminance in the vicinity of the image display device can be performed.

Specifically, in an arrangement that a degree of the luminance correction is changed in accordance with an output of the luminance sensor, the light source controlling means preferably keeps the luminance of the light source at a constant value in spite of the inputted video signal when the luminance sensor detects that the luminance in the vicinity of the image display device is higher than a predetermined value.

For example, in a case where the vicinity of the image display device is very bright, even a bright image which is largely white is unclear to see due to the luminance of the vicinity with the decrease of screen luminance. However, this arrangement makes it possible to prevent the image to be unclear to see because the reduction of the luminance of the light source is not performed when the vicinity of the image display device is bright.

The image display device of the present invention may be arranged such that the weighting means weights luminance information that corresponds to a specific area in a full screen of the inputted video signal.

This makes it possible to perform more appropriate luminance correction because the luminance correction of the light source can be performed based on luminance of an area which effectively contributes to image display.

The image display device of the present invention may be arranged such that the histogram determining means determines the histogram distribution according to luminance information that corresponds to a specific area in a full screen of the input video signal.

This makes it possible to perform more appropriate luminance correction because the luminance correction of the light source can be performed based on luminance of an area which effectively contributes to image display.

### INDUSTRIAL APPLICABILITY

This invention is applicable to, for example, a liquid crystal display device which performs moving image display.

1. An image display device comprising a light source and a light modulation device which attenuates light from the light source in accordance with a video signal so as to change the luminance of a display image, the image display device, comprising:
weighting means for weighting luminance information of the video signal inputted thereto;
image characteristic value determining means for determining an image characteristic value of one frame by taking by one frame an average of the luminance information weighted by the weighting means; and
light source controlling means for performing luminance correction of the light source in accordance with the image characteristic value determined by the image characteristic value determining means.

2. An image display device which displays an image of an inputted video signal on a light modulation device having a light source, comprising:
histogram determining means for dividing luminance information of one frame of the inputted video signal into a plurality of luminance information classifications and determining histogram distribution of the luminance information classifications;
weighting means for weighting the histogram distribution of the luminance information classifications, the histogram distribution being determined by the histogram determining means;
image characteristic value determining means for determining an image characteristic value by taking an average of a result of the histogram distribution of the luminance information classifications, the histogram distribution being weighted by the weighting means; and
light source controlling means for performing luminance correction of the light source in accordance with the image characteristic value determined by the image characteristic value determining means.

3. The image display device as set forth in claim 1 wherein the weighting means performs weighting by using a function of the luminance information of the inputted video signal.

4. The image display device of claim 2 wherein:
the weighting means uses a function of the luminance information of the inputted video signal and selects the function according to the histogram distribution of the luminance information classifications, the histogram distribution being determined by the histogram determining means.

5. The image display device as set forth in claim 1 wherein the weighting means performs weighting in such a manner that luminance information of higher luminance side is weighted relatively more than luminance information of lower luminance side.

6. The image display device as set forth in claim 1 wherein the light source controlling means performs such luminance correction that the luminance of the light source is decreased when the image characteristic value determined by the image characteristic value determining means is equal to or more than the first predetermined value.

7. The image display device as set forth in claim 1 wherein the light source controlling means performs such luminance correction that the luminance of the light source is decreased when the image characteristic value determined by the image characteristic value determining means is equal to or less than the second predetermined value.

8. The image display device as set forth in claim 2 wherein the light source controlling means performs such luminance correction that the luminance of the light source is decreased when the image characteristic value determined by the image characteristic value determining means is equal to or less than the second predetermined value in a case where the number of pixels in the luminance information classifications whose luminance information is equal to or more than predetermined luminance information in the histogram distribution corresponding to each luminance information classification determined by the histogram determining means is equal to or less than a predetermined value.

9. The image display device as set forth in claim 7, comprising:
a video signal level correction means for correcting a signal level of a video signal in such a manner that the signal level is raised, the video signal being inputted thereto and being to be supplied to the light modulation device,
the light source controlling means performing the luminance correction of the light source in such a manner that the luminance of the light source is decreased, and
the video signal level correction means performing the correction of the signal level in such a manner that the signal level of the video signal is raised.

10. The image display device as set forth in claim 9 wherein the light source controlling means and the video signal level correction means perform the luminance correction and the correction of the signal level in order that a peak luminance level of the light modulation device may be constant before and after the luminance correction of the light source and the correction to the signal level of the video signal when the image characteristic value determined by the image characteristic value determining means is equal to or less than the second predetermined value.

11. The image display device as set forth in claim 9 wherein the light source controlling means and the video signal level correction means perform the luminance correction and the correction of the signal level in order that an average luminance level of the light modulation device may be constant before and after the luminance correction of the light source and the correction to the signal level of the video signal when the image characteristic value determined by the image characteristic value determining means is equal to or less than the second predetermined value.

12. The image display device as set forth in claim 11, comprising:
a luminance sensor for detecting luminance in the vicinity of the image display device,
the light source controlling means changing degree of the correction in accordance with an output of the luminance sensor.

13. The image display device as set forth in claim 12 wherein the light source controlling means keeps the luminance of the light source at a constant value in spite of the inputted video signal when the luminance sensor detects that the luminance in the vicinity of the image display device is higher than a predetermined value.

14. The image display device as set forth in claim 1 wherein the weighting means weights luminance information that corresponds to a specific area in a full screen of the inputted video signal.

15. The image display device as set forth in claim 2 wherein the histogram determining means determines the histogram distribution according to luminance information that corresponds to a specific area in a full screen of the input video signal.

16. The image display device as set forth in claim 2 wherein the weighting means performs weighting by using a function of the luminance information of the inputted video signal.

17. The image display device as set forth in claim 2 wherein the weighting means performs weighting in such a manner that luminance information of higher luminance side is weighted relatively more than luminance information of lower luminance side.

18. The image display device as set forth in claim 8, comprising:
a video signal level correction means for correcting a signal level of a video signal in such a manner that the signal level is raised, the video signal being inputted thereto and being to be supplied to the light modulation device,
the light source controlling means performing the luminance correction of the light source in such a manner that the luminance of the light source is decreased, and
the video signal level correction means performing the correction of the signal level in such a manner that the signal level of the video signal is raised.

19. The image display device as set forth in claim 2, comprising:
a luminance sensor for detecting luminance in the vicinity of the image display device,
the light source controlling means changing degree of the correction in accordance with an output of the luminance sensor.
